(19) United States
(12) Patent Application Publication
(10) Pub. No.: US 2013/0229490 A1
(43) Pub. Date: Sep. 5, 2013

(54) DIGITAL SIGNAGE SYSTEM AND METHOD FOR DISPLAYING CONTENT ON DIGITAL SIGNAGE

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/527,913

(22) Filed: Jun. 20, 2012

(30) Foreign Application Priority Data
Mar. 2, 2012 (TW) 101106877

(51) Int. Cl. H04N 13/02

(52) U.S. Cl. 348/46; 348/E13.074

(57) ABSTRACT

An exemplary digital signage method includes obtaining an image captured by a camera, the image comprising distance information indicating distances between the camera and objects shot by the camera. The method then creates a 3D scene model according to the captured image and the distances between the camera and objects captured by the camera. Next, the method determines whether one or more persons appear in the created 3D scene model. The method then determines a distance between the one or more persons and the digital signage when one or more persons appear in the created 3D scene model, determines the content according to a stored relationship and the determined distance, obtains the determined content, and further controls the at least one display to display the obtained content.

### BACKGROUND

1. Technical Field

The present disclosure relates to digital signage systems, and particularly, to a digital signage system capable of automatically adjusting the displayed content according to the distance between the people and a digital signage and a digital signage method.

2. Description of Related Art

A conventional digital signage includes at least one display for displaying a stored content, to show menus, information, advertising and other messages. However, most digital signage cannot determine the distance between the people and the digital signage, and cannot automatically adjust the displayed content according to the distance between the people and the digital signage, which cannot attract the person to view the content displayed by the digital signage, it may influence the effect of the digital signage.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a digital signage connected with one camera and one audio playing device in accordance with an exemplary embodiment.

FIG. 2 is a schematic view showing the digital signage of FIG. 1.

FIG. 3 is a schematic view showing how to determine the rotation angle and the rotation direction of a virtual object.

FIG. 4 is a schematic view showing that the people view the displayed content of the digital signage of FIG. 1.

FIG. 5 is a flowchart of a digital signage method in accordance with an exemplary embodiment.

### DETAILED DESCRIPTION

The embodiments of the present disclosure are described with reference to the accompanying drawings.

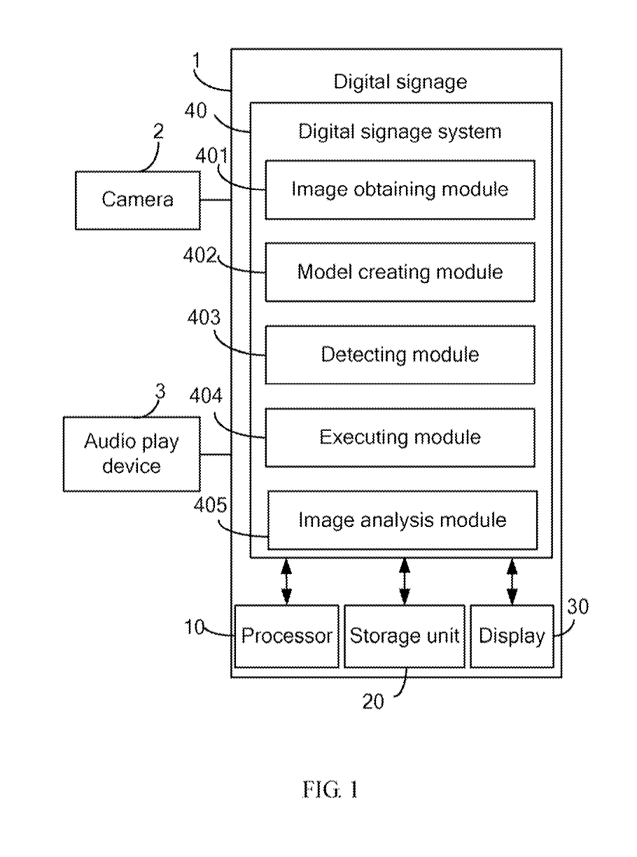

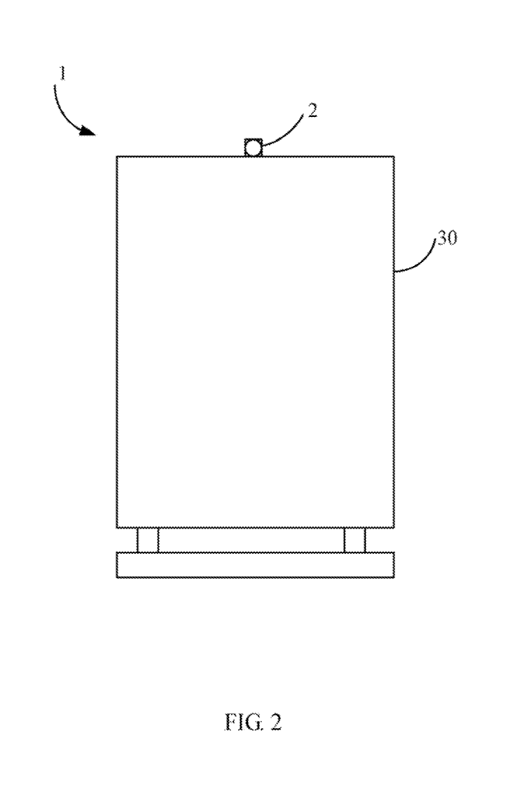

FIGS. 1-2 are schematic diagrams illustrating a digital signage 1. The digital signage 1 can automatically adjust the displayed content according to the distance between the people and the digital signage 1. The digital signage 1, connected to a camera 2, can analyze an image captured by the camera 2, determine whether one or more persons appear in the image, and further display the corresponding content according to the distance between the one or more persons and the digital signage 1.

The camera 2 is arranged on an appropriate position of the digital signage 1, and the distance between the person and the camera 2 can be considered as the distance between the person and the digital signage 1. Each captured image shot by the camera 2 includes distance information indicating the distance between the camera 2 and any object in the field of view of the camera 2. In the embodiment, the camera 2 is a Time of Flight (TOF) camera.

The digital signage 1 includes a processor 10, a storage unit 20, a display 30, and a digital signage system 40. In the embodiment, the digital signage system 40 includes an image obtaining module 401, a model creating module 402, a detecting module 403, and an executing module 404. One or more programs of the above function modules may be stored in the storage unit 20 and executed by the processor 10. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The storage unit 20 further stores a number of three-dimensional (3D) person models, a number of content, and a table. Each 3D person module has a number of characteristic features. The 3D person models may be created based on a number of person images pre-collected by the camera 2 and the distances between the camera 2 and the person recorded in the pre-collected person images. The table records the relationship between the distance and the content. In the embodiment, when the distance between the person and the digital signage 1 is less than a preset value (such as 15 meters), a detailed content is displayed, such as “5-10 August limited time promotion: A: trademark discount up to 50%; B: trademark preference limit; C: trademark lucky draw; D: trademark new item allowance”. When the distance between the person and the digital signage 1 is more than or equal to the preset value, a brief content is displayed, such as “5-10 August limited time promotion”. In other embodiments, each distance range corresponds to one content.

The image obtaining module 401 obtains images captured by the camera 2. The model creating module 402 creates a 3D scene model according to the captured image and the distances between the camera 2 and objects shot by the camera 2.

The detecting module 403 determines whether one or more persons appear in the created 3D scene model. In detail, the detecting module 403 extracts data from the created 3D scene model corresponding to the shape of the one or more objects appearing in the created 3D scene model. The detecting module 403 then compares each of the extracted data with characteristic features of each of the 3D person models, to determine whether one or more persons appear in the created 3D scene model. If the extracted data does not match the data as to feature characteristics of any of the 3D person models, the detecting module 403 determines that no person appears in the created 3D scene model. Otherwise, the detecting module 403 determines that one or more persons appear in the created 3D scene model. In the embodiment, the detecting module 403 further determines the pixels of one of created 3D scene model whose distance information indicates a distance less than a preset value, such as 15 meters, determines the area, which is covered by the determined pixels, and further determines whether one or more persons appear in the determined area.

The executing module 404 determines the distance between the one or more persons and the digital signage 1 when one or more persons appear in the created 3D scene model. In detail, when one person appears in the created 3D scene model, the executing module 404 determines the distance between the determined one person and the digital signage 1. When more persons appear in the created 3D scene model, the executing module 404 determines the distance between each of the determined persons and the digital signage 1, determines an average distance of the determined distance, and considers the determined average distance as the distance between the more persons and the digital signage 1. For example, when the distance between a person A and the camera 2 is 8 meters, the distance between another person B and the camera 2 is 10 meters, and the distance between a third person C and the camera 2 is 12 meters. The executing module 404 determines that the distance between the more persons and the camera 2 is 10 meters.

The executing module 404 further determines the content according to the stored relationship and the determined distance between the one or more persons and the camera 2, obtains the determined content, and further controls the at least one display 30 to display the obtained content. For example, when the distance between the one or more persons and the camera 2 is 16 meters, the executing module 404 controls the display 30 to display a brief content “5-10 August limited time promotion”.

In the embodiment, the digital signage 1 is further connected to an audio playing device 3. The storage unit 20 further stores audio files corresponding to the stored contents. The executing module 404 further obtains the audio file corresponding to the obtained content, and further controls the audio playing device 3 to play the obtained audio file.

In the embodiment, each of the at least one display 30 includes a first display area 31 and a second display area 32. The storage unit 20 further stores a 3D virtual object model and a viewable angle of the lens of the camera 2. In the embodiment, the 3D virtual object model is a 3D virtual person model, in the initial, the facing orientation of the 3D virtual person model is perpendicular to the digital signage 1. In other embodiments, the 3D virtual object model can be pets or other objects, and the facing orientation of the 3D virtual person model can be varied according to need. The digital signage system 40 further includes an image analysis module 405. The image analysis module 405 determines the orientation of the one or more persons relative to the virtual 3D person model, and determines the angle between the optical axis and a virtual straight line defined by the camera 2 and the one or more persons. The image analysis module 405 then determines the movement direction and the movement angle of the virtual 3D person model according to the determined orientation and the determined angle.

In detail, the image analysis module 405 determines the set of coordinates of each of the one or more persons in the image, determines the average set of coordinates of the one or more persons in the image, and considers the point of the average set of coordinates as the average persons. The image analysis module 405 further extends a line from the average persons which is perpendicular to the optical axis of the camera 2 in the image and determines a first intersection point where the line intersects the optical axis of the camera 2. The image analysis module 405 further extends the line to the boundary of the image adjacent to the average persons to form an extending line. Further, the image analysis module 405 determines a second intersection point where the extending line intersects the boundary of the image. Furthermore, the image analysis module 405 determines the ratio of the lengths formed by the average persons and the second intersection point to the length formed by the average persons and the first intersection point. The ratio of those lengths in the image will be the same as the ratio in fact. The image analysis module 405 determines the orientation of the average persons relative to the virtual 3D person model, determines the angle between the optical axis and the virtual straight line defined by the camera 2 and the average persons according to the determined ratio in fact and the stored viewable angle of the lens of the camera 2, and determines the movement direction and the movement angle according to the determined orientation and the determined angle.

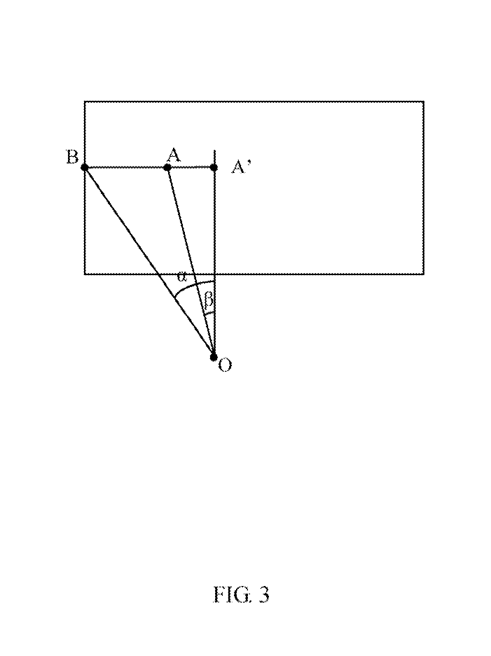

For example, in FIG. 3, the camera 2 is represented by a point 0, the average persons is represented by a point A. The first intersection point is represented by a point A′, and the second intersection point is represented by a point B. The ratio of the length of line AA′ in the image to the length of line AB in the image is 1:2, and the stored horizontal field of view of the camera 2 a is 60 degrees. Thus the determining module 34 determines that the orientation of the average persons relative to the virtual 3D person model is right and the angle β between line OA and line OA′ is 30°.

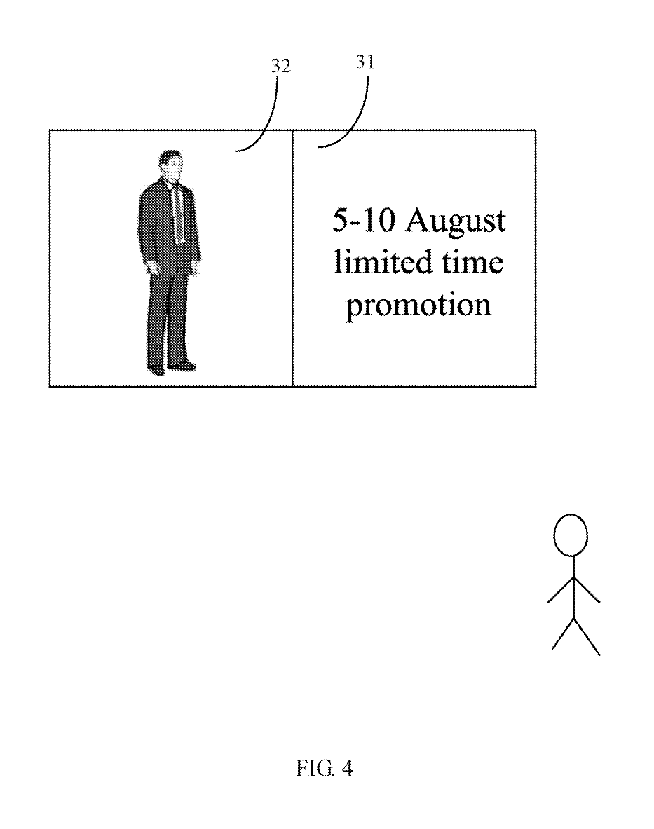

The executing module 404 controls the at least one display 30 to display the obtained content on the first display area 31 and display the rotated virtual 3D person model on the second display area 32, and controls the 3D virtual person to rotate toward the determined movement direction and rotate the determined movement angle. Thus, the face orientation of the 3D virtual person model is toward the person ahead, it gives the one or more persons a feeling that the 3D virtual person model speaks toward them (see FIG. 4).

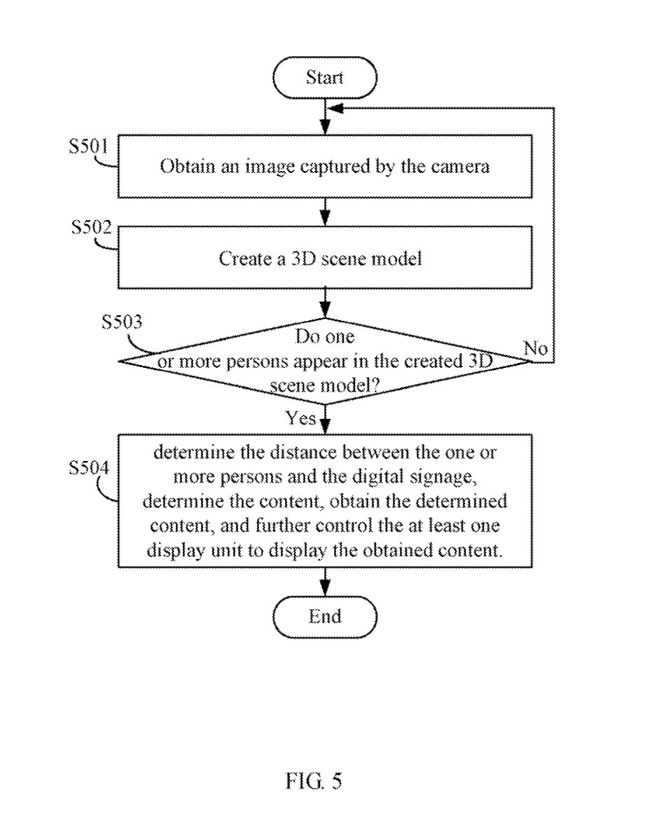

FIG. 5 shows a method for displaying different content in a digital signage in accordance with an exemplary embodiment.

In step S501, the image obtaining module 401 obtains an image captured by the camera 2.

In step S502, the model creating module 402 creates a 3D scene model according to the captured image and the distances between the camera 2 and objects captured by the camera 2.

In step S503, the detecting module 403 determines whether one or more persons appear in the created 3D scene model. If one or more persons appear in the created 3D scene model, the procedure goes to step S504. If no person appears in the created 3D scene model, the procedure goes to step S501. In detail, the detecting module 403 extracts data from the created 3D scene model corresponding to the shape of the one or more objects appearing in the created 3D scene model, and compares each of the extracted data with characteristic features of each of the 3D person models, to determine whether one or more persons appear in the created 3D scene model. If the extracted data does not match the data as to feature characteristics of any of the 3D person models, the detecting module 403 determines that no person appears in the created 3D scene model. Otherwise, the detecting module 403 determines that one or more persons appear in the created 3D scene model. In the embodiment, the detecting module 403 further determines the pixels of one of created 3D scene model whose distance information indicates a distance less than a preset value, such as 15 meter, determines the area covered by the determined pixels, and further determines whether one or more persons appear in the determined area.

In step S504, the executing module 404 determines the distance between the one or more persons and the digital signage 1, determines the content according to the stored relationship and the determined distance between the one or more persons and the camera 2, obtains the determined content, and further controls the at least one display 30 to display the obtained content. The method of determining the distance between the one or more persons and the digital signage 1 is described as follows: when one person appears in the created 3D scene model, the executing module 404 determines the distance between the determined one person and the digital signage 1. When more persons appear in the created 3D scene model, the executing module 404 determines the distance between each of the determined more persons and the digital signage 1. The executing module 404 also determines an average distance of each of the determined more persons, and determines the determined average distance as the distance between the more persons and the digital signage 1.

In the embodiment, the procedure of controlling the at least one display 30 to display the obtained content is executed before the procedure of controlling the audio playing device to play the audio file.

In detail, the executing module 404 obtains the audio file corresponding to the obtained content, and further controls the audio play unit to play the obtained audio file.

In the embodiment, the procedure of controlling the at least one display 30 to display the obtained content is executed before the procedure of controlling one virtual 3D person model to rotate toward the movement direction and rotate the movement angle.

In detail, the image analysis module 405 determines the orientation of the one or more persons relative to the virtual 3D person model. Then the image analysis module 405 determines the angle between the optical axis and a virtual straight line defined by the camera 2 and the one or more persons, and determines the movement direction and the movement angle of the virtual 3D person model according to the determined orientation and the determined angle. In detail, the image analysis module 405 determines the set of coordinates of each of the one or more persons in the image, determines the average set of coordinates of the one or more persons in the image, and considers the point of the average set of coordinates as the average persons. The image analysis module 405 further extends a line from the average persons as recognized which is perpendicular to the optical axis of the camera 2 in the image and determines a first intersection point where the line intersects the optical axis of the camera 2. The image analysis module 405 further extends the line to the boundary of the image adjacent to the average person to form an extending line. Furthermore, the image analysis module 405 determines a second intersection point where the extending line intersects the boundary of the image, and further still determines the ratio of the lengths formed by the average persons and the second intersection point to the length formed by the average persons and the first intersection point. The ratio of those lengths in the image will be the same as the ratio in fact. The image analysis module 405 determines the orientation and the angle between the optical axis and the virtual straight line defined by the camera 2 and the average persons according to the determined ratio in fact and the stored viewable angle of the lens of the camera 2.

The executing module 404 further controls the at least one display 30 to display the obtained content on the first display area 31 and display the virtual 3D person model on the second display area 32, and controls the 3D virtual person model to rotate toward the determined movement direction and rotate the determined movement angle.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A digital signage comprising:
a storage unit storing a plurality of contents and a relationship between each of the plurality of contents and a distance between the person and the digital signage;
a processor;
one or more programs stored in the storage unit, executable by the processor, the one or more programs comprising:
an image obtaining module operable to obtain an image captured by a camera, the image comprising distance information indicating distances between the camera and objects shot by the camera;
a model creating module operable to create a 3D scene model according to the captured image and the distances between the camera and objects captured by the camera;
a detecting module operable to determine whether one or more persons appear in the created 3D scene model; and
an executing module operable to determine a distance between the one or more persons and the digital signage when one or more persons appear in the created 3D scene model, determine the content according to the stored relationship and the determined distance, obtain the determined content, and further control the at least one display to display the obtained content.

2. The digital signage as described in claim 1, wherein the detecting module is further operable to: determine pixels of one of created 3D scene model whose distance information indicates a distance less than a preset value, determine an area which is covered by the determined pixels, and further determine whether one or more persons appear in the determined area.

3. The digital signage as described in claim 1, wherein when one person appears in the created 3D scene model, the executing module is operable to determine a distance between the determined one person and the digital signage.

4. The digital signage as described in claim 1, wherein when more persons appear in the created 3D scene model, the executing module is operable to determine a distance between each of the determined more persons and the digital signage, determine an average distance of the determined distance, and consider the determined average distance as the distance between the more persons and the digital signage.

5. The digital signage as described in claim 1, wherein the storage unit further stores a plurality of audio files, the executing module is further operable to obtain the audio file corresponding to the obtained content, and further control the audio playing device to play the obtained audio file.

6. The digital signage as described in claim 1, further comprising an image analysis module, wherein the image analysis module is operable to determine the orientation of the one or more persons relative to the virtual 3D person model, determine the angle between the optical axis and a virtual straight line defined by the camera and the one or more persons, and determine the movement direction and the movement angle of the virtual 3D person model according to the determined orientation and the determined angle, the executing module is further operable to control the at least one display to display the obtained content on one first display area of each of the at least one display and display the rotated virtual 3D person model on one second display area of each of the at least one display, and control the 3D virtual person to rotate toward the determined movement direction and rotate the determined movement angle.

7. The digital signage as described in claim 6, wherein the image analysis module is operable to:
determine the set of coordinate of each of the one or more persons in the image, determine the average set of coordinate of the one or more persons in the image, and consider the point of the average set of coordinate as the average persons;
extend a line from the average persons which is perpendicular to the optical axis of the camera in the image and determine a first intersection point where the line intersects the optical axis of the camera;
extend the line to the boundary of the image adjacent to the average persons to form an extending line, determine a second intersection point where the extending line intersects the boundary of the image, and further determine the ratio of the lengths formed by the average persons and the second intersection point to the length formed by the average persons and the first intersection point; and
consider the ratio of those lengths in the image the same as the ratio in actual, determine the orientation of the average persons relative to the virtual 3D person model, determine the angle between the optical axis and the virtual straight line defined by the camera and the average persons according to the determined ratio in fact and the stored viewable angle of the lens of the camera, and determine the movement direction and the movement angle according to the determined orientation and the determined angle.

8. A digital signage method implemented by a digital signage, the digital signage comprising a storage unit storing a plurality of contents and a relationship between each of the plurality of contents and a distance between the person and the digital signage, the digital signage method comprising:
obtaining an image captured by a camera, the image comprising distance information indicating distances between the camera and objects shot by the camera;
creating a 3D scene model according to the captured image and the distances between the camera and objects captured by the camera;
determining whether one or more persons appear in the created 3D scene model; and
determining a distance between the one or more persons and the digital signage when one or more persons appear in the created 3D scene model, determining the content according to the stored relationship and the determined distance, obtaining the determined content, and further controlling the at least one display to display the obtained content.

9. The method as described in claim 8, wherein the method further comprises:
determining pixels of one of created 3D scene model whose distance information indicates a distance less than a preset value, determining an area which is covered by the determined pixels, and further determining whether one or more persons appear in the determined area.

10. The method as described in claim 8, wherein the method further comprises:
determining a distance between the determined one person and the digital signage when one person appears in the created 3D scene model.

11. The method as described in claim 8, wherein the method further comprises:
determining a distance between each of the determined more persons and the digital signage when more persons appear in the created 3D scene model, determining an average distance of the determined distance, and considering the determined average distance as the distance between the more persons and the digital signage.

12. The method as described in claim 8, the storage unit further storing a plurality of audio files, wherein the method further comprises:
obtaining the audio file corresponding to the obtained content, and further controlling the audio playing device to play the obtained audio file.

13. The method as described in claim 8, wherein the method further comprises:
determining the orientation of the one or more persons relative to the virtual 3D person model, determining the angle between the optical axis and a virtual straight line defined by the camera and the one or more persons, and determining the movement direction and the movement angle of the virtual 3D person model according to the determined orientation and the determined angle; and
controlling the at least one display to display the obtained content on one first display area of each of the at least one display and display the rotated virtual 3D person model on one second display area of each of the at least one display, and controlling the 3D virtual person to rotate toward the determined movement direction and rotate the determined movement angle.

14. The method as described in claim 13, wherein the method further comprises:
determining the set of coordinate of each of the one or more persons in the image, determining the average set of coordinate of the one or more persons in the image, and considering the point of the average set of coordinate as the average persons;
extending a line from the average persons which is perpendicular to the optical axis of the camera in the image and determining a first intersection point where the line intersects the optical axis of the camera;
extending the line to the boundary of the image adjacent to the average persons to form an extending line, determining a second intersection point where the extending line intersects the boundary of the image, and further determining the ratio of the lengths formed by the average persons and the second intersection point to the length formed by the average persons and the first intersection point; and
considering the ratio of those lengths in the image the same as the ratio in actual, determining the orientation of the average persons relative to the virtual 3D person model, determining the angle between the optical axis and the virtual straight line defined by the camera and the average persons according to the determined ratio in fact and the stored viewable angle of the lens of the camera, and determining the movement direction and the movement angle according to the determined orientation and the determined angle.

15. A non-transitory storage medium storing a set of instructions, the set of instructions capable of being executed by a processor of a digital signage, cause the digital signage to perform a digital signage method, the digital signage comprising a storage unit storing a plurality of contents and a relationship between each of the plurality of contents and a distance between the person and the digital signage, the method comprising:
obtaining an image captured by a camera, the image comprising a distance information indicating distances between the camera and objects shot by the camera;
creating a 3D scene model according to the captured image and the distances between the camera and objects captured by the camera;
determining whether one or more persons appear in the created 3D scene model; and
determining a distance between the one or more persons and the digital signage when one or more persons appear in the created 3D scene model, determining the content according to the stored relationship and the determined distance, obtaining the determined content, and further controlling the at least one display to display the obtained content.

16. The storage medium as described in claim 15, wherein the method further comprises:
determining pixels of one of created 3D scene model whose distance information indicates a distance less than a preset value, determining an area which is covered by the determined pixels, and further determining whether one or more persons appear in the determined area.

17. The storage medium as described in claim 15, wherein the method further comprises:
determining a distance between each of the determined more persons and the digital signage when more persons appear in the created 3D scene model, determining an average distance of the determined distance, and considering the determined average distance as the distance between the more persons and the digital signage.

18. The storage medium as described in claim 15, the storage unit further storing a plurality of audio files, wherein the method further comprises:
obtaining the audio file corresponding to the obtained content, and further controlling the audio playing device to play the obtained audio file.

19. The storage medium as described in claim 15, wherein the method further comprises:
determining the orientation of the one or more persons relative to the virtual 3D person model, determining the angle between the optical axis and a virtual straight line defined by the camera and the one or more persons, and determining the movement direction and the movement angle of the virtual 3D person model according to the determined orientation and the determined angle; and
controlling the at least one display to display the obtained content on one first display area of each of the at least one display and display the rotated virtual 3D person model on one second display area of each of the at least one display, and controlling the 3D virtual person to rotate toward the determined movement direction and rotate the determined movement angle.

20. The storage medium as described in claim 19, wherein the method further comprises:
determining the set of coordinate of each of the one or more persons in the image, determining the average set of coordinate of the one or more persons in the image, and considering the point of the average set of coordinate as the average persons;
extending a line from the average persons which is perpendicular to the optical axis of the camera in the image and determining a first intersection point where the line intersects the optical axis of the camera;
extending the line to the boundary of the image adjacent to the average persons to form an extending line, determining a second intersection point where the extending line intersects the boundary of the image, and further determining the ratio of the lengths formed by the average persons and the second intersection point to the length formed by the average persons and the first intersection point; and
considering the ratio of those lengths in the image the same as the ratio in actual, determining the orientation of the average persons relative to the virtual 3D person model, determining the angle between the optical axis and the virtual straight line defined by the camera and the average persons according to the determined ratio in fact and the stored viewable angle of the lens of the camera, and determining the movement direction and the movement angle according to the determined orientation and the determined angle.
